(19) United States
(12) Patent Application Publication
(10) Pub. No.: US 2025/0328516 A1
(43) Pub. Date: Oct. 23, 2025

(54) DCF-BASED DATA LIFECYCLE MANAGEMENT

(71) Applicant: Dell Products L.P., Round Rock, TX (US)

(72) Inventors: Pankaj Pande, Carlingford (AU); Stephen J. Todd, North Andover, MA (US)

(21) Appl. No.: 18/638,613

(22) Filed: Apr. 17, 2024

(51) Int. Cl. G06F 16/23

(52) U.S. Cl. CPC G06F 16/2365

(57) ABSTRACT

One example method includes receiving, at a node of a data lifecycle management system, a data stream, performing an assessment of the data stream, based on the assessment, assigning a data confidence score to the data stream, providing the data confidence score to an immutable ledger, and performing a data lifecycle operation on the data stream based on a policy to which the data confidence score corresponds. The data lifecycle operation may be performed by the node and may include data processing, data storage, data usage, data archiving, and data destruction.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to data lifecycle management. More particularly, at least some embodiments relate to systems, hardware, software, computer-readable media, and methods, for the use of data confidence principles and techniques in the context of data lifecycle management.

### BACKGROUND

Managing the lifecycle of data in edge environments, from creation to eventual disposal, is important for maintaining data integrity, meeting regulatory requirements, and optimizing storage resources. However, current data lifecycle management systems often do not account for the varying levels of data confidence affecting their treatment by various systems, and at various stages, throughout the data management lifecycle.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an example data confidence fabric (DCF), according to one embodiment.

FIG. 2 discloses aspects of an example of a data lifecycle.

FIG. 3 discloses aspects of an architecture, according to one embodiment.

FIG. 4 discloses aspects of a method, according to one embodiment.

FIG. 5 discloses aspects of a method, according to one embodiment.

FIG. 6 discloses aspects of an example computing entity that is configured and operable to perform any of the disclosed methods, processes, and operations.

### DETAILED DESCRIPTION OF SOME EXAMPLE EMBODIMENTS

Embodiments disclosed herein generally relate to data lifecycle management. More particularly, at least some embodiments relate to systems, hardware, software, computer-readable media, and methods, for the use of data confidence principles and techniques in the context of data lifecycle management.

One example embodiment comprises a method for assessing and assigning data confidence at various stages of a data lifecycle management process. As such, in one embodiment, one or more of the elements involved in aspects of a data lifecycle management process may comprise respective nodes, of a data confidence fabric (DCF). One embodiment of such a method may comprise operations including: at one or more stages of a data lifecycle, assessing a stream of data; based on the assessing, assigning a confidence score to the stream of data; and, handling the data, as part of a data lifecycle management operation, in accordance with the assigned confidence score.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments is that data may, during a data lifecycle, be intelligently handled using confidence scores generated as the data passes through one or more stages of the data lifecycle. In an embodiment, the performance of one or more stages of a data lifecycle management process may be guided by data confidence measures and considerations. Various other advantages of one or more example embodiments will be apparent from this disclosure.

### A. Aspects of an Example Architecture and Environment

The following is a discussion of aspects of example operating environments for various embodiments. This discussion is not intended to limit the scope of the disclosure or claims, or the applicability of the embodiments, in any way.

In general, embodiments may be implemented in connection with systems, software, and components, that individually and/or collectively form computing environments, such as edge computing environments for example. One or more embodiments may be employed in computing environments that comprise, or implement, a portion of a data confidence fabric (DCF).

Note that as used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

In general, a DCF may include various nodes, which may comprise hardware and/or software, through which the data passes as the data moves through the DCF. Trust information, and confidence information, concerning the data may be inserted at one or more of these nodes as the data transits the DCF. The trust information may indicate, for example, a relative extent to which the data may be considered trustworthy by a user of the data, such as an application for example. The confidence information may indicate a relative level of confidence in the trustworthiness of the data.

Thus, if data passes through a node that is considered untrustworthy for some reason, the confidence in the integrity and reliability of that data may be relatively low. That is, the trust information may be a function of, for example, the nature and operation of the node(s) through which the data passes. To illustrate, if a node that handles the data is determined to have inadequate security controls, data that has passed through that node may be assessed as relatively untrustworthy and the confidence in that data may be correspondingly low. Thus, an application that may have a need for the data may consider the confidence level, or confidence score, of the data in determining whether or not to use that data.

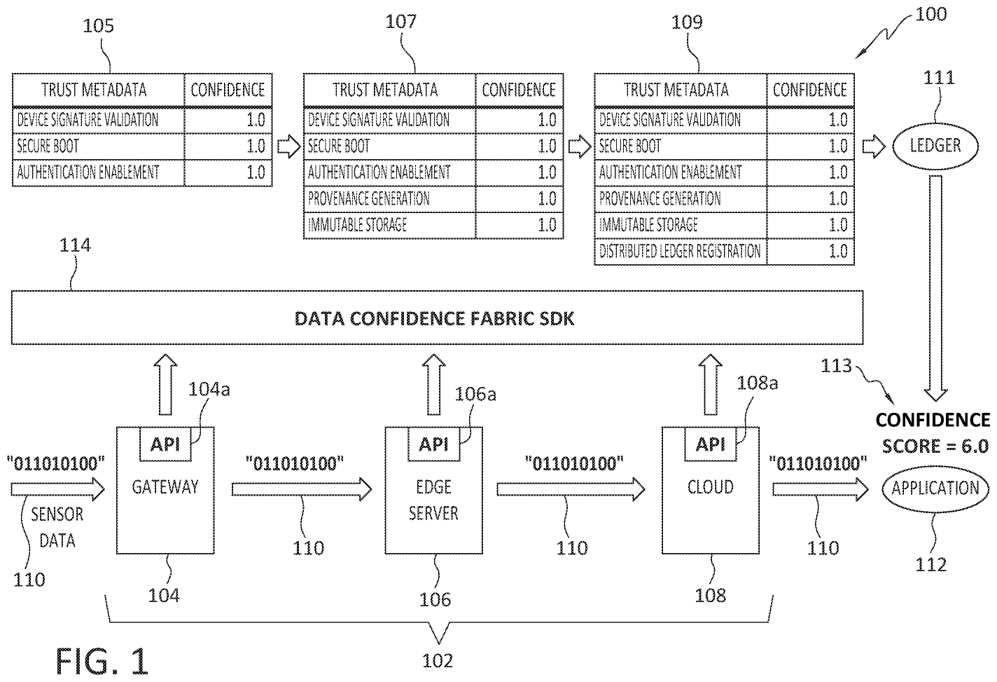

Turning now to FIG. 1, details are provided concerning an example DCF Annotation and Scoring Framework, or simply DCF, 100 in connection with which an embodiment may be employed. As shown, the DCF 100 may include various nodes 102, examples of which may include a gateway 104, an edge server 106, and a cloud site 108, through which data 110 may pass. The data 110 may ultimately be used, or consumed, by an end user 112, such as an application for example.

In an embodiment, the data 110 may be generated by a node such as a sensor, which may comprise an IoT (Internet of Things) edge device for example. Each of the nodes 102 may comprise a respective API 104a, 106a, and 108a, that the nodes 102 may use to communicate confidence information to a DCF SDK (software development kit) 112.

Consider, in the example of FIG. 1, the layers of trust that may be provided in the DCF 100. Particularly, the gateway 104 may have an embedded Intel TPM chip and it may use that chip to perform “trust services” on behalf of the owner of the data 110. In the example above, a “secure boot” annotation, in the trust metadata 105 for the gateway 104, may indicate that the gateway 104 has not been tampered with. The TPM chip may also provide keys used to perform signature services on the data 110. As well, in the example of FIG. 1, the edge server 106 may leverage an ARM secure enclave to perform a “trust service,” inspecting the data 110 and performing analytics on it. Finally, a cloud application, such as the Dell Streaming Data

Platform running at the cloud site 108, may perform additional trust services on the data 110 such as, for example, inspect the data 110 for drift, as may be done if the data is coming from a sensor with a well-known range of values and/or a long history of stable behavior.

As further indicated in FIG. 1, trust metadata generated at each state of the data 110 journey may be added to trust metadata generated at upstream nodes. Thus, for example, the trust metadata 105 may have been generated at the gateway 104, and the trust metadata 107 may include both the trust metadata 105 and trust metadata generated at the edge server 106. Finally, the trust metadata 109 may include trust metadata generated at the cloud site 108, as well as the trust metadata generated at the edge server 106, and at the gateway 104.

The accumulated trust metadata 109 may be stored in an immutable ledger 111 that may be accessible by the application 112. Additionally, or alternatively, a confidence score 113 may be generated based on the trust metadata 109, and made available to the application 112 or other data 110 end user(s).

The recipient, that is, the data owner, of these trust services that insert trust metadata may require this level of trust insertion in order that their applications, such as the application 112 for example, can produce insights from the data 110 with confidence that the data 110 is trustworthy. The trust insertion functionality may be of great value because it may significantly reduce the risk of dangerous actuation or other business logic resulting from low-quality, erroneous, or malicious data. Trust services may also significantly reduce the risk of regulatory compliance violations. Preventing these violations may enable trust service recipients to avoid regulatory fines. One or more embodiments may enable the vendors providing these trust/confidence services to accurately track the provision of these services in a DCF, and an embodiment may also enable the vendor to bill the data owner, and/or other trust service consumers. Details concerning some example functionalities that may be provided by an embodiment are set forth in the following section.

With continued reference to the example of FIG. 1, it was noted that the gateway 104, edge server 106, and cloud site 108, are examples of nodes between, and among, which data may pass as the data transits the DCF 100. In one embodiment, any one or more of such nodes may be supplemented, or replaced, by various nodes, which may comprise systems, components, devices, and applications, that handle respective aspects of a data lifecycle management process, examples of which are disclosed elsewhere herein. Thus, the example DCF 100 is adaptable for use in data lifecycle management processes and operations.

### B. Data Lifecycle

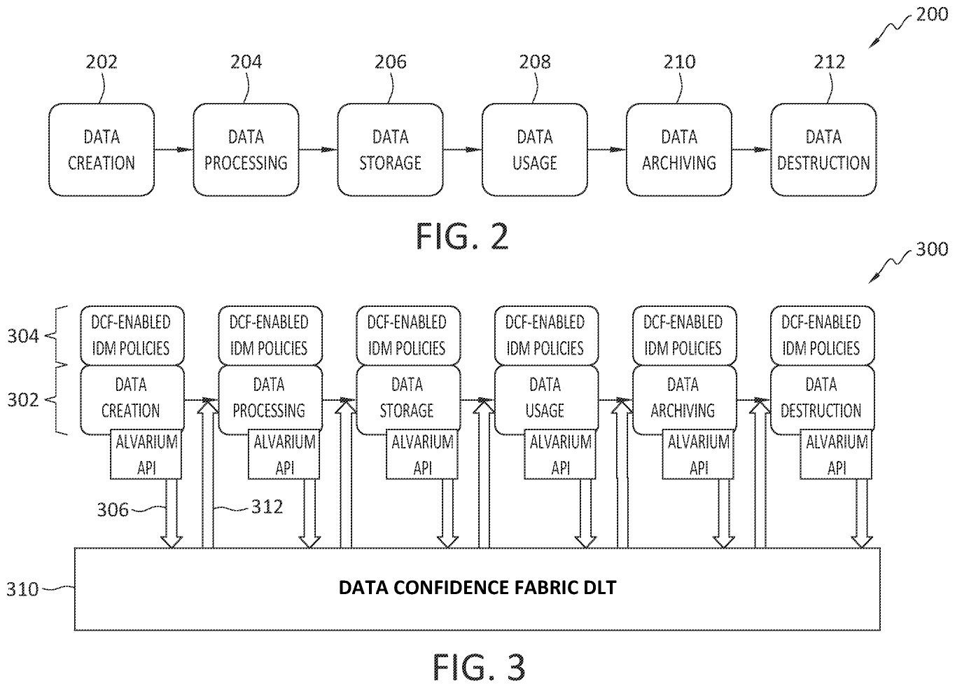

One or more embodiments may be implemented with respect to one, some, or all, stages of a data lifecycle. One example of such a data lifecycle is disclosed at https://www.oreilly.com/library/view/data-governance-the/9781492063483/ch04.html (“Oreilly”) which is incorporated herein in its entirety by this reference), and illustrated at 200 in FIG. 2.

As shown in FIG. 2, data may pass through various stages during its life, where such stages may include, but are not limited to, data creation 202, data processing 204, data storage 206, data usage 208, data archiving 210, and data destruction 212. In an embodiment, data confidence scores and metadata may be determined at any, and all, of these various stages as part of, and/or to guide, the performance of data lifecycle operations. In an embodiment, each of the stages disclosed in FIG. 200 may be performed at/by a respective node, or group of nodes, and these nodes may form a portion of a DCF.

### C. Detailed Discussion of Aspects of an Embodiment

### C.1 Overview

One embodiment comprises a DCF-based data lifecycle management system, and associated operations, that considers data confidence scores when determining policies for data lifecycle operations such as, but not limited to, data storage, placement, retention, archiving, and disposal. This approach may ensure that data with relatively higher confidence levels, that is, relative to confidence levels of other data, is handled differently, based on the confidence levels, throughout its lifecycle, lowering risks associated with poor decision-making based on lower confidence data. For example, data with a relatively high confidence score may be prioritized, such as for a data processing operation for example. As another example, data with a relatively low confidence score reflecting, for example, a possibility that the data may have been compromised by an attacker, may be stored in a vault at a data storage stage of a data lifecycle, such as the data storage stage 206 of the data lifecycle 200 of FIG. 2. In an embodiment, the DCF-enabled environment, which may comprise an edge environment or an edge environment, for example, may generate and maintain data confidence scores for all data streams by updating a ledger, such as an immutable ledger, and the corresponding confidence score.

### C.2 Integration With DCF

With attention now to the example architecture 300 of FIG. 3, it can be seen that existing data management software may be integrated with an API (application program interface), such as the Alvarium API for example, to enable creation data confidence metadata and scores at each stage of any data lifecycle process, and each stage may also access the metadata and scores from previous phases in the lifecycle and then build business logic around the metadata and score values.

As shown in the example of FIG. 3, the architecture 300, which may comprise a portion of a DCF, may comprise various nodes 302 at which respective lifecycle management functions may be performed. As shown, the nodes 302 may include respective nodes for processes including, but not limited to, data creation, data processing, data storage, data usage, data archiving, and data destruction.

Each of the nodes 302 may be associated with respective lifecycle data management (LDM) policies 304 that may be used to guide the performance of operations by the node 302 with respect to data received by the node 302. For example, the LDM policies 304 employed by the data storage node 302 may require that data with a low confidence score be stored in a vault.

In an embodiment, one or more of the LDM policies 304 employed by a node 302 may correspond to a respective data confidence score determined by that node 302. That is, based on the determined data confidence score, a node 302 may handle its data in a variety of ways, according to the applicable LDM policies 304.

As shown in FIG. 3, a node 302 may communicate 306, by way of an API 308, a data confidence score, generated by that node, to a ledger 310, such as an immutable ledger for example. In an embodiment, the ledger 310 may comprise a blockchain. In one particular embodiment, the ledger 310 may comprise a DCF DLT (distributed ledger technology) ledger. As the data moves through the various temporal stages of its lifecycle, the data may be assessed for confidence, and handled accordingly, by the various nodes 302 in the lifecycle chain. In one embodiment, the lifecycle of the data ends with the destruction of the data. However, this example is provided only for illustration. In an embodiment, one or more of the stages may be skipped or omitted, one or more stages may be added, and a data lifecycle may end at any of the stages. Further, the data may spend different respective amounts of time at each stage. Thus, for example, a data archiving stage may last much longer than a data destruction stage.

With continued attention to FIG. 3, particular attention is directed now to the data creation stage of the disclosed data lifecycle. In one embodiment, and as disclosed in Oreilly for example, data creation may comprise three types of input, namely: [1] data acquisition from a third party; [2] data manually entered by an employee; and, [3] data automatically retrieved from devices, such as an IoT device for example. In the IoT use case, according to one embodiment, if the data arrives from a DCF, it may be assumed that the data has already been annotated and scored. For the other two cases, that is, data acquisition and manual data entry, it is possible that the data has zero confidence. It is noted that the zero confidence does not necessarily indicate that the data is problematic although that could be the case, rather, only that little or nothing may be known about that data.

Finally, as further indicated in FIG. 3, any node 302 may access 312, from the ledger 310, data confidence information written to the ledger 310 by any of the other nodes 302. By accessing this data confidence information, the accessing node 302 may use that information to update the confidence score of the data, and/or to guide operations performed by that node 302 with respect to the data.

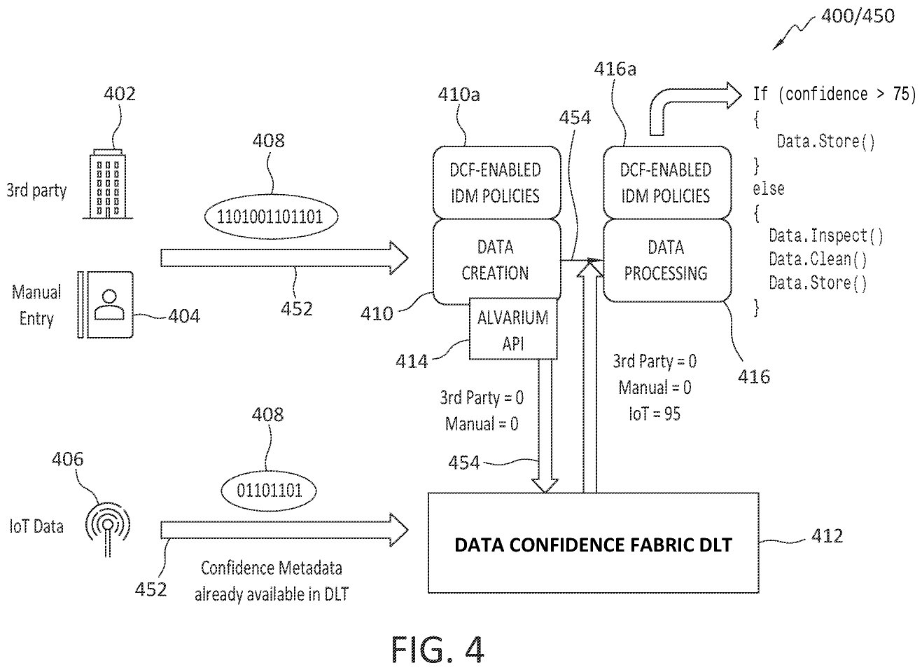

With attention now to FIG. 4, an architecture 400, which may comprise a data lifecycle management system, and associated method 450, according to one embodiment, are disclosed. As shown, the architecture 400 may comprise various entities 402, 404, and 406, by way of which data 408 may be created/obtained 452. In more detail, the inputting/creation 452 of the data may define a data creation stage 410. The data thus input/created 452 may then be assessed by the node that first receives the created data 408. This assessment may result in the generation of a data confidence score that is then conveyed 454 by the node to a ledger 412 by way of an API 414.

In the example of FIG. 4, the node 406 may be an element of a DCF and, as such, confidence information associated with the data 408 provided by the node 406 may already reside in the ledger 412. On the other hand, the data 408 received from the nodes 402 and 404 may have unknown provenances and, as such, may initially be assigned data confidence scores of ‘0’ as shown in FIG. 4. This assignment may be performed as dictated by LDM policies 410a associated with the data creation stage 410.

Once the data 408 creation/intake of the data creation stage 410 has been completed, the data 408 may then enter 454 a data processing stage 416. In general, the data may be processed at the data processing stage 416 according to LDM policies 416a associated with the data processing stage 416, and possibly based as well on data confidence scores previously entered in the ledger 412 and relating to the data 408. For example, the LDM policies 416a may specify that, at the data processing stage 416, no processing is performed on data with a confidence score greater than 75, such as, for example, the IoT (confidence score=95) received from the node 406, and the data may then be stored in a data storage phase. On the other hand, the LDM policies 416a may also specify that data with low confidence scores, such as the data received from the nodes 402 and 404, should be dynamically inspected and cleaned prior to storage.

As noted elsewhere herein, DCF-aware data lifecycle management policies, such as the LDM policies 410a and 416a, for example, may be configured to consider confidence metadata when determining retention, archiving, and disposal actions, and/or any other actions of a data lifecycle management method and system. For example, high-confidence data may be retained for longer periods, or prioritized for comprehensive analysis, while lower-confidence data may be subjected to stricter controls regarding storage and usage, or is archived sooner.

### D. Further Discussion

As will be apparent from this disclosure, one or more embodiments may possess various useful features and aspects, although no embodiment is required to possess any of such features and aspects. The following example is illustrative. One or more embodiments may comprise a data lifecycle management system, and associated methods, that integrates data confidence scores into data handling policies so as to enhance overall system performance and compliance with regulatory requirements. By way of contrast, conventional approaches to data lifecycle management systems do generate, or consider, data confidence scores, nor incorporate such scores into data handling policies and actions. In one example use case, an edge environment may process sensitive medical data, ensuring that high-confidence data is retained and prioritized for analysis, while low-confidence data is strictly controlled, archived, or disposed of, per LDM policies for handling sensitive information.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

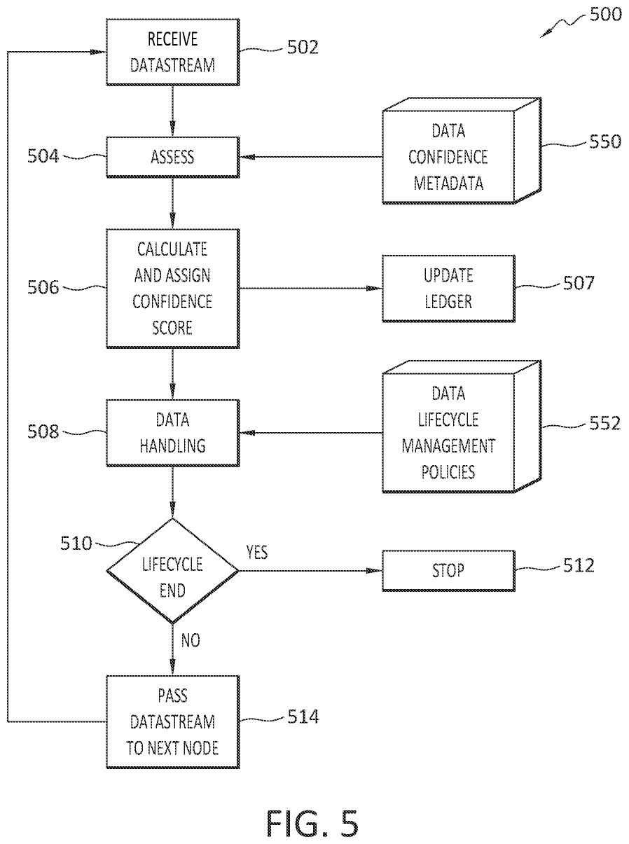

With reference now to FIG. 5, an example method according to one embodiment is denoted at 500. In an embodiment, successive instances of the method 500 may be performed in serial fashion at each node of a data lifecycle management system.

The method 500 may begin when a node of a data lifecycle management system receives a datastream, possibly from another node. The node that received 502 the datastream may then assess 504 using, for example, hardware and/or software of the node, the datastream to enable the calculation 506 and assignment of a confidence score for the datastream. In an embodiment, the assessment 504 and calculation 506 may comprise obtaining data confidence metadata 550, from a ledger, that was stored in the ledger by another node. The data confidence metadata 550 may be used to calculate 506 the confidence score. Further, the calculation 506 may consider the outcome of the assessment 504 in determining a data confidence score. In this way, the data confidence score ultimately assigned to the datastream by the node may take into account data confidence metadata 550 generated by one or more other nodes, but also the assessment performed by the node that received the datastream. After the data confidence score has been calculated and assigned 506 by the node to the datastream, the node may also store 507 that data confidence score in the ledger.

When the data confidence score for the datastream has been determined 506, the node may then handle 508 the data according to the lifecycle function implemented by that node. For example, if the function of the node is storage, then the node may store the datastream. As further indicated in FIG. 5, the data handling operations 508 may be performed in accordance with requirements specified in data lifecycle management policies 552. Thus, for example, the data lifecycle management policies 552 may specify that if data confidence score for the datastream meets or exceeds a threshold, the data can be immediately stored without any cleaning or scanning.

Next, a check 510 may be performed to determine if the end of the data lifecycle has been reached. If so, the method 500 may terminate 512. If not, the datastream may be passed 514 by the node to the next node in succession, and the operations beginning with 502 repeated by/at the next node

### F. Further Example Embodiments

Following are some further example embodiments. These are presented only by way of example and are not intended to limit the scope of this disclosure or the claims in any way.
Embodiment 1. A method, comprising: receiving, at a node of a data lifecycle management system, a stream that includes data; performing an assessment of the data; based on the assessment, assigning a data confidence score to the data; providing the data confidence score to an immutable ledger; and performing a data lifecycle operation on the data based on a policy to which the data confidence score corresponds.
Embodiment 2. The method as recited in any preceding embodiment, wherein the data lifecycle operation is performed by the node and comprises one of: data processing; data storage; data usage; data archiving; or, data destruction.
Embodiment 3. The method as recited in any preceding embodiment, wherein the assessment comprises obtaining data confidence metadata, generated at an upstream node, from the immutable ledger.
Embodiment 4. The method as recited in any preceding embodiment, wherein the assessment comprises evaluating, by the node, the data to determine a confidence score of the data as received by the node.
Embodiment 5. The method as recited in any preceding embodiment, wherein the policy is specific to the data lifecycle operation and to the node.
Embodiment 6. The method as recited in any preceding embodiment, wherein the data comprises one or more of: third party data; manually entered data; and data generated by an edge device.
Embodiment 7. The method as recited in any preceding embodiment, wherein the data stream is received from a data confidence fabric and is associated with a data confidence annotation and a data confidence score.
Embodiment 8. The method as recited in any preceding embodiment, wherein the policy maps the data confidence score to an aspect of the data lifecycle operation.
Embodiment 9. The method as recited in any preceding embodiment, wherein the data lifecycle operation that is performed varies depending upon a value of the data confidence score.
Embodiment 10. The method as recited in any preceding embodiment, wherein except when the data lifecycle operation is destruction of the data, control of the data is passed to a succeeding node after the data lifecycle operation has been performed.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

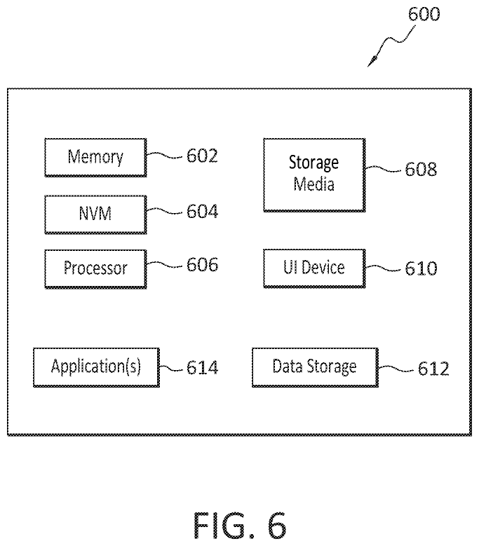

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

1. A method, comprising:
receiving, at a node of a data lifecycle management system, a stream that includes data;
performing an assessment of the data;
based on the assessment, assigning a data confidence score to the data;
providing the data confidence score to an immutable ledger;
determining whether the data confidence score is great than or equal to a threshold;
in a case where it is determined that the data confidence score is greater than or equal to the threshold, immediately storing the data without performing any cleaning or scanning operations of the data as a data lifecycle operation according to a data lifecycle policy; and
in a case where it is determined that the data confidence score is not greater than or equal to the threshold, performing inspecting, cleaning, and storing of the data as the data lifecycle operation according to the data lifecycle policy.

2. The method as recited in claim 1, wherein the data lifecycle operation is performed by the node and comprises one of: data processing; data storage; data usage; data archiving; or, data destruction.

3. The method as recited in claim 1, wherein the assessment comprises obtaining data confidence metadata, generated at an upstream node, from the immutable ledger.

4. The method as recited in claim 1, wherein the assessment comprises evaluating, by the node, the data to determine a confidence score of the data as received by the node.

5. The method as recited in claim 1, wherein the data lifecycle policy is specific to the data lifecycle operation and to the node.

6. The method as recited in claim 1, wherein the data comprises one or more of: third party data; manually entered data; and data generated by an edge device.

7. The method as recited in claim 1, wherein the data stream is received from a data confidence fabric and is associated with a data confidence annotation and a data confidence score.

8. The method as recited in claim 1, wherein the data lifecycle policy maps the data confidence score to an aspect of the data lifecycle operation.

9. The method as recited in claim 1, wherein the data lifecycle operation that is performed varies depending upon a value of the data confidence score.

10. The method as recited in claim 1, wherein except when the data lifecycle operation is destruction of the data, control of the data is passed to a succeeding node after the data lifecycle operation has been performed.

11. A non-transitory storage medium having stored therein instructions that are executable by one or more hardware processors to perform operations comprising:
receiving, at a node of a data lifecycle management system, a stream that includes data;
performing an assessment of the data;
based on the assessment, assigning a data confidence score to the data;
providing the data confidence score to an immutable ledger;
determining whether the data confidence score is great than or equal to a threshold;
in a case where it is determined that the data confidence score is greater than or equal to the threshold, immediately storing the data without performing any cleaning or scanning operations of the data as a data lifecycle operation according to a data lifecycle policy; and
in a case where it is determined that the data confidence score is not greater than or equal to the threshold, performing inspecting, cleaning, and storing of the data as the data lifecycle operation according to the data lifecycle policy.

12. The non-transitory storage medium as recited in claim 11, wherein the data lifecycle operation is performed by the node and comprises one of: data processing; data storage; data usage; data archiving; or, data destruction.

13. The non-transitory storage medium as recited in claim 11, wherein the assessment comprises obtaining data confidence metadata, generated at an upstream node, from the immutable ledger.

14. The non-transitory storage medium as recited in claim 11, wherein the assessment comprises evaluating, by the node, the data stream to determine a confidence score of the data as received by the node.

15. The non-transitory storage medium as recited in claim 11, wherein the data lifecycle policy is specific to the data lifecycle operation and to the node.

16. The non-transitory storage medium as recited in claim 11, wherein the data comprises one or more of: third party data; manually entered data; and data generated by an edge device.

17. The non-transitory storage medium as recited in claim 11, wherein the data is received from a data confidence fabric and is associated with a data confidence annotation and a data confidence score.

18. The non-transitory storage medium as recited in claim 11, wherein the data lifecycle policy maps the data confidence score to an aspect of the data lifecycle operation.

19. The non-transitory storage medium as recited in claim 11, wherein the data lifecycle operation that is performed varies depending upon a value of the data confidence score.

20. The non-transitory storage medium as recited in claim 11, wherein except when the data lifecycle operation is destruction of the data, control of the data is passed to a succeeding node after the data lifecycle operation has been performed.
